(19) United States
(12) Patent Application Publication
(10) Pub. No.: US 2009/0090231 A1
(43) Pub. Date: Apr. 9, 2009

(54) Band Saw Machine

(75) Inventor: Akihiro Kondo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: KOKUHO CO., LTD., Kanagawa (JP)

(21) Appl. No.: 11/995,622

(22) PCT Filed: Jul. 15, 2005
(86) PCT No.: PCT/JP2005/013522

§ 371 Date: Jan. 14, 2008

(51) Int. Cl. B27B 13/00

(52) U.S. Cl. 83/818

(57) ABSTRACT

A band saw machine is provided with a body frame, two wheels provided on the body frame and rotating by driving force on an inclined plane which is inclined to a basic plane which is flush with a cutting plane, a saw blade formed in loop and strained between the two wheels, a stabilizing member bringing a portion of the saw blade which runs around a cutting section which is fixed between the wheels and on an edge intersected the inclined plane with the basic plane close to the basic plane in near-parallel, and a depressing mechanism fixed up adjacent to the cutting section side of the stabilizing member to clear the gap between the saw blade and the basic plane.

The band saw machine, for example in a ship on building, can finely cut a protrusion on a floor of a bottom to its root to remove it. Thus, an extra effort to smooth a floor can be saved.

### FIELD OF THE INVENTION

The present invention relates to a band saw machine to be used for cutting metals.

### DESCRIPTION OF THE RELATED ART

In one example of related arts, there is a band saw machines provided with a pair of wheels which are fixed up in parallel, and a looped saw blade which runs tight between the wheels. For example, in cutting a steel product by the band saw machine, the steel product is set on a cutting section which is provided between the wheels, and is slid toward the cutting section to be cut. Otherwise, the machine is approximated to a fixed steel product to cut the product on the cutting section.

The above conventional band saw machine can cut a steel product to a desired size. However, for example, in a ship on building, a protrusion on a floor face of a bottom cannot be cut to its root with the conventional band saw machine because the looped saw blade cannot be brought close to the floor face. As a result, for shaping the floor face smooth, an extra effort for cutting the protrusion off to its root is needed to remove the remained root thereof perfectly. The disadvantage of taking such an extra effort has remained an issue to be solved.

### SUMMARY OF THE INVENTION

The present invention was carried out in consideration of such problems in related arts, and it is an object in the present invention to provide a band saw machine not only cutting off a steel product to a desired size, but also, for example, for removing a protrusion on a floor face of a bottom in a ship on building, finely cutting the protrusion off to its root to save an extra effort to smooth the floor face.

The inventors, as a result of assiduous studies for achieving the above object, found out a way to accomplish the object by using a band saw machine provided with a depressing mechanism and a saw blade which is shaped in loop and is depressed by the depressing mechanism to be approximated to a floor face, and then they have accomplished the present invention.

One aspect of the invention includes a band saw machine provided with: a body frame; two wheels provided on the body frame: and rotating by driving force on an inclined plane which is inclined to a basic plane which is flush with a cutting plane; a saw blade formed in loop and strained between the two wheels; a stabilizing member bringing: a portion of the saw blade which runs around a cutting section which is fixed between the wheels and on an edge intersected the inclined plane with the basic plane: close to the basic plane in near-parallel; and a depressing mechanism fixed up adjacent to the cutting section side of the stabilizing member to clear a gap between the saw blade and the basic plane.

In one preferred embodiment of the invention, the depressing mechanism can regulate the gap between the saw blade and the basic plane.

In further preferred embodiment of the invention, the band saw machine is further provided with a base frame which supports the body frame to allow the body frame to move in the direction which the cutting section moves toward or away from a workpiece.

In yet further preferred embodiment of the invention, the band saw machine is further provided with a wheel driving source serving as a motor to rotate the wheels, and a frame driving source serving as a motor to move the body frame, wherein the base frame is fixable on a wall or ceiling with a magnet or a suction mechanism, and the fixed base frame allows the body frame to move in the direction which the body frame moves toward or away from the base frame.

In another embodiment of the invention, the stabilizing member and the depressing mechanism may be provided not only on the saw blade ingress side of the cutting section, but also on the saw blade egress side thereof.

In another preferred embodiment of the invention, for removing swarf which is produced from a workpiece through cutting it, an inlet port of an aspirator or a nozzle of a blower is fixed up in the cutting section.

For example, when being transported to a place to use, a band saw machine may be suspended by a suspension device such as a chain block or may be loaded on a carriage to be carried to a destination.

For facilitating an adjustment of the machine position to a workpiece, another preferred embodiment of the invention is further provided with a retractable caster.

In a band saw machine of the present invention, a portion of a saw blade which runs into a cutting section fixed between two wheels is approximated to a basic plane with being controlled in near-parallel with the basic plane by a stabilizing member, and is pressed by a depressing mechanism with almost no gap between the saw blade and the basic plane. For example, when using for removing a protrusion on a floor face of a bottom in a ship on building, a band saw machine cuts the protrusion off with bringing a basic plane of a body frame in close contact with the floor face, namely a cutting plane, that is to say, cuts the protrusion off with placing the body frame on the floor face to be able to remove the protrusion to its root perfectly. Accordingly, an extra effort to smooth a floor can be saved.

A preferred embodiment of the invention, which has a structure described above, for example, can cut a protrusion off with slightly leaving a root of the protrusion. That is, a band saw machine of the invention can meet diverse needs of cutting.

In a further preferred embodiment of the invention, as a band saw machine has a structure described above, for example, when being used for removing a protrusion on a floor face of a bottom in a ship on building, the band saw machine is placed on the floor face so that a base frame has contact with the floor face, and a body frame is moved toward or away from the base frame with rotating wheels to cut the protrusion off automatically. Thus, a protrusion can be removed easily.

A yet further preferred embodiment of the invention, which has a structure described above, can readily remove a protrusion existing not only on a floor face but also on a wall or on a ceiling.

### BRIEF DESCRIPTION OF THE DRAWINGS

FIG. 1 is a diagrammatic perspective view illustrating an overall appearance of one aspect of a band saw machine of the invention.

FIG. 2 is a diagrammatic side view of a band saw machine of FIG. 1.

FIG. 3 is a diagrammatic front view of a saw blade ingress side of a band saw machine of FIG. 1.

FIG. 4 is a diagrammatic bottom view of a saw blade ingress side of a band saw machine of FIG. 1.

### DETAILED DESCRIPTION OF THE INVENTION

Hereinafter, the present invention will be explained in detail with referring to embodiments; however, is not limited to what is shown in the embodiments.

### Embodiment

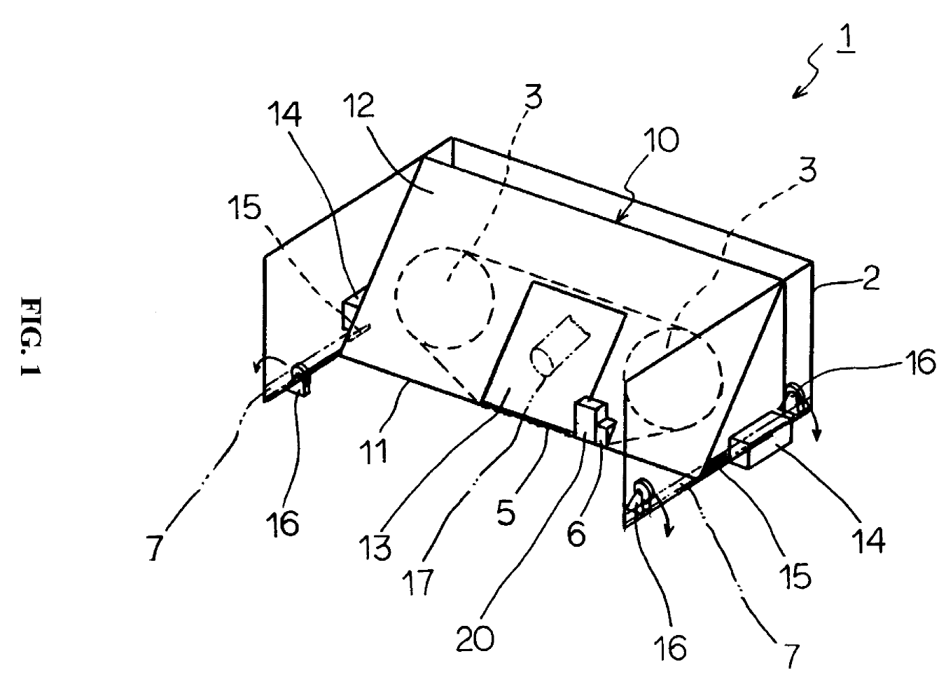

FIGS. 1 to 4 show one embodiment of a band saw machine of the invention.

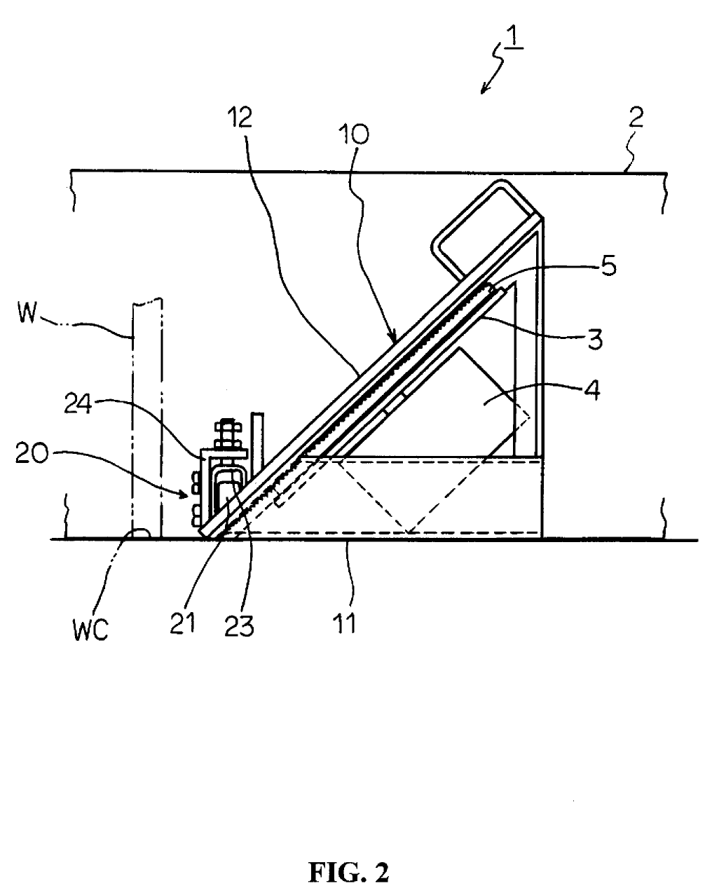

Referring to FIGS. 1 and 2, a band saw machine 1 is provided with a base frame 2 build up with plates in channel shape, a body frame 10 housed in the base frame 2, two wheels 3, 3 provided on the body frame 10 and rotating on an inclined plane 12 inclined 45 degrees to a basic plane 11 which is flush with a cutting plane WC, a motor 4, shown only in FIG. 2, supplying driving force to a first wheel 3, a saw blade 5 formed in loop and strained between the two wheels 3, 3, a stabilizing member 6 aligned near the cutting section 13 which is fixed between the wheels 3, 3 and on an edge intersected the inclined plane 12 with the basic plane 11, and a depressing mechanism 20 fixed up adjacent to the cutting section 13 side of the stabilizing member 6.

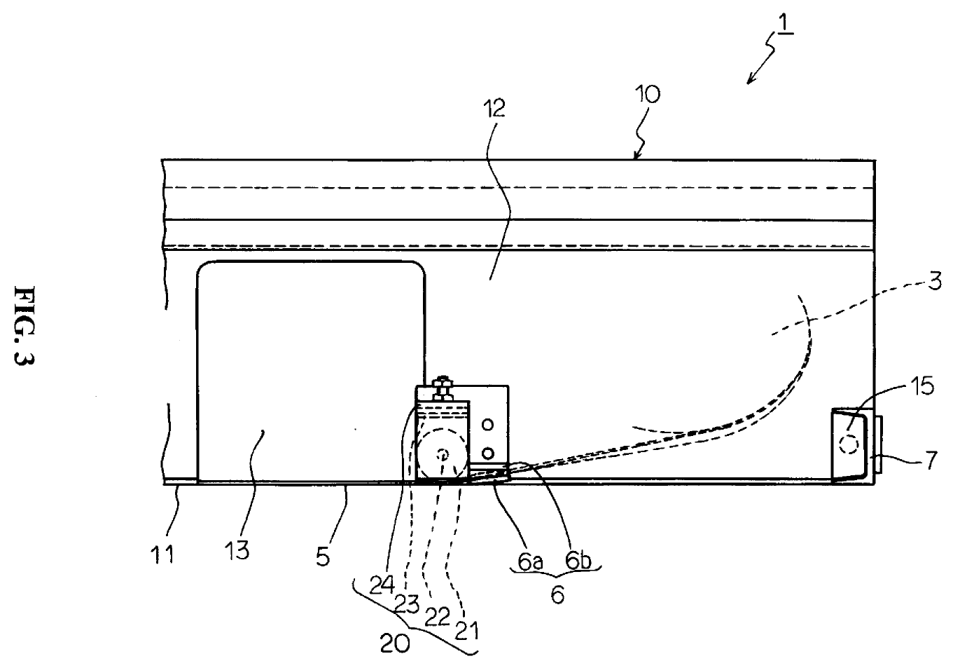

Referring to FIG. 3, the stabilizing member 6 is composed of two block 6a, 6b which are placed opposite at a predefined interval, that is a interval a little wider than the thickness of the saw blade 5. The stabilizing member 6 dampens the vibration of the saw blade 5 which runs into the cutting section 13, and brings the saw blade 5 close to the basic plane 11 in near-parallel.

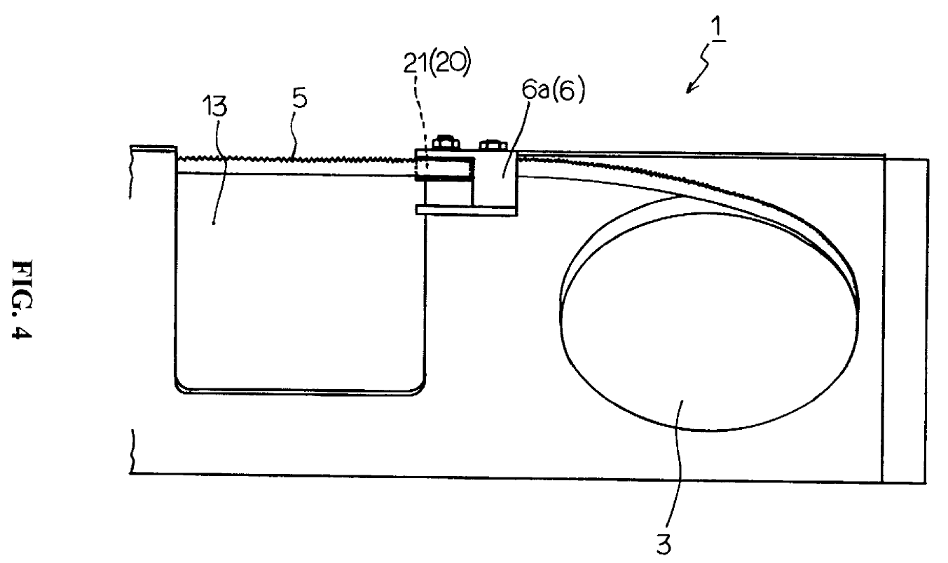

Referring to FIG. 4, the depressing mechanism 20 is provided with a roller 21, a holder 23 supports a shaft 22 of the roller 21 to rotate flexibly, a housing 24 supports the holder 23 to move toward or away from the basic plane 11, namely, in FIGS. 2 and 3, to move in a vertical direction. The depressing mechanism 20 adjusts the position of the holder 23 to the basic plane 11 to nearly equalize the gap between the roller 21 and the basic plane 11 with the thickness of the saw blade 5, and then the gap between the saw blade 5 and the basic plane 11 approximates practically zero.

The stabilizing member 6 and the depressing mechanism 20 are also provided at the saw blade running out side of the cutting section 13, which are not shown in FIG. 4.

The band saw machine 1 is provided with a slide mechanism, not shown in figures, in the base frame 2. The slide mechanism slides the body frame 10 in the direction which the cutting section 13 moves toward or away from a workpiece W, namely in a horizontal direction in FIG. 2.

The slide mechanism is provided with a motor for activating the body frame. Generated power may be transmitted by, for example, a ball screw or a rack-and-pinion. The ball screw is composed of a screw shaft which is connected to an output shaft of the motor fixed on the base frame 2, and a nut which is fixed on the body frame 10, wherein the screw shaft is screwed around the inner surface of the nut. The rack-and-pinion is composed of a pinion which is provided on the output shaft of the motor fixed on the body frame 10, and a rack which is provided on the base frame 2, wherein the pinion gears with the rack.

Two magnets 14, shown in only FIG. 1, are provided on the either side of the base frame 2 to fix the base frame 2 on a wall or a ceiling. Sliders 15 are provided on the four corners of the body frame 10 and slide on grooves of channel steels 7 attached on the base frame 2 to slide the body frame 10 to or from the base frame 2 fixed on a wall or a ceiling.

The band saw machine 1 is transported to a place to use with a suspension device, such as a chain block, or a carriage. Retractable casters 16 are provided on the four corners of the base frame 2 to facilitate an adjustment of the machine position for use.

In the band saw machine 1, an inlet port 17 is provided in the cutting section 13. The inlet port 17 communicates with an aspirator, not illustrated in figures, to remove swarf of a workpiece Hereinafter, a procedure for removing a protrusion, that is a workpiece, on a floor of a bottom in a ship on building with using this aspect of the invention will be explained.

A band saw machine 1 is transported to a place to use by a suspension device, such as a chain block, or a carriage. Retractable casters 16 pivot in the direction of arrows in FIG. 1 and the machine 1 is moved with the casters to adjust its position. The retractable casters 16 are stored again and a base frame 2 is set up on a floor near a protrusion W.

A motor 4 is activated to drive a first wheel 3, and then a looped saw blade 5 which is strained between two wheels 3, 3 is rotated and an aspirator, not illustrated in figures, is also activated.

A motor of a slide mechanism for driving a body frame 10 is activated and allows the body frame 10 to start on sliding in the direction of approximating a cutting section 13 to the protrusion W. The saw blade 5 approaches the protrusion W at a predefined sliding speed and abuts the protrusion W to cut the protrusion W off.

Referring to FIGS. 3 and 4, a portion of the saw blade 5 which runs into the cutting section 13 is approximated to a basic plane 11 with being controlled in near-parallel with the basic plane 11 by a stabilizing member 6, and then, the portion of the saw blade 5 is depressed by a roller 21 of a depressing mechanism 20 until leaving almost no gap between the portion of the saw blade 5 and the basic plane 11. The protrusion W is finely cut off to its root to be removed from the floor. This brings an advantage to omit an extra effort to remove the protrusion perfectly.

In the band saw machine 1, a holder 23 of the depressing mechanism 20 moves toward or away from the basic plane 11. This allows a position adjustment of the roller 21 to the basic plane 11. The band saw machine 1 can work with complying diversified requests on cutting, for example, a request to remove the protrusion with leaving a little bit of the root.

The band saw machine 1 is also provided with a slide mechanism which slides the body frame 10 in the direction which the cutting section 13 moves toward or away from a workpiece W. A protrusion W, namely a workpiece W, can be cut off automatically. Thus, the slide mechanism facilitates an operation for removing a protrusion.

In the band saw machine 1, magnets 14 are provided on the base frame 2 to fix the base frame 2 on a wall or a ceiling. Further, the body frame 10 is slidable to the base frame 2 which is fixed on a wall or a ceiling. Thus, these facilitate an operation for removing a protrusion existing not only on a floor face but also on a wall face or a ceiling face.

In the band saw machine 1, retractable casters 16 are provided on the four corners of the base frame 2 to facilitate an adjustment of the machine position for use.

In the band saw machine 1, an inlet port 17 is provided in the cutting section 13 and communicates with an aspirator, not illustrated in figures, to remove swarf of a workpiece. Thus, this prevents the saw blade 5 from clogging.

### INDUSTRIAL APPLICABILITY

As explained in the foregoing, a band saw machine having the structure in accordance with the disclosed embodiments and their equivalents, for example in a ship on building, can finely cut off a protrusion on a floor of a bottom to its root. This brings good advantage that an extra effort to smooth a floor face can be saved.

A band saw machine having a structure in accordance with a preferred embodiment or its equivalent can work with complying diversified requests on cutting workpiece.

A band saw machine having a structure in accordance with a further preferred embodiment or its equivalent, for example in a ship on building, can easily remove a protrusion on a floor of a bottom.

A band saw machine having a structure in accordance with a still further preferred embodiment or its equivalent can easily remove a protrusion not only on a floor but also on a wall or a ceiling.

1. A band saw machine provided with:
a body frame;
two wheels provided on the body frame and rotating by driving force on an inclined plane which is inclined to a basic plane which is flush with a cutting plane;
a saw blade formed in loop and strained between the two wheels;
a stabilizing member bringing: a portion of the saw blade which runs around a cutting section which is fixed between the wheels and on an edge intersected the inclined plane with the basic plane: close to the basic plane in near-parallel; and
a depressing mechanism fixed up adjacent to the cutting section side of the stabilizing member to clear the gap between the saw blade and the basic plane.

2. The band saw machine of claim 1, wherein the depressing mechanism regulate the gap between the saw blade and the basic plane.

3. The band saw machine of claim 1, further provided with a base frame which supports the body frame to allow the body frame to move in the direction which the cutting section moves toward or away from a workpiece.

4. The band saw machine of claim 3, further provided with:
a first motor serving as a wheel driving source to rotate the wheels, and
a second motor serving as a frame driving source to move the body frame, wherein the base frame is fixable on a wall or ceiling, and the fixed base frame allows the body frame to move in the direction which the body frame moves toward or away from the base frame.
